(19) United States
(12) Patent Application Publication
(10) Pub. No.: US 2008/0028232 A1
(43) Pub. Date: Jan. 31, 2008

(54) Key sequence recognition and password hardening system and method

(76) Inventor: Steven L. Bender, Solvang, CA (US)

Correspondence Address: DUANE MORRIS LLP, 101 WEST BROADWAY, SUITE 900, SAN DIEGO, CA, 92101-8285, US

(21) Appl. No.: 11/810,261

(22) Filed: Jun. 4, 2007

Related U.S. Application Data
(63) Continuation-in-part of application No. 10/305,493, filed on Nov. 26, 2002, now Pat. No. 7,206,938.
(60) Provisional application No. 60/413,490, filed on Sep. 24, 2002.

(51) Int. Cl. H04K 1/00

(52) U.S. Cl. 713/186

(57) ABSTRACT

A user recognition and identification system and method to identify keyboard users. Key text is evaluated against previously recorded keystrokes by the user for the presence of repeatable patterns that are unique to an individual. Rhythms associated with passwords are screened compared to a database of banned rhythms.

### PRIORITY

This application is a continuation-in-part of U.S. patent application with Ser. No. 10/305,493, which claims priority to the provisional application filed on Sep. 24, 2002 with Ser. No. 60/413,490.

### BACKGROUND

1. Field of the Invention

Aspects of the present invention relate to biometric identification, and more particularly to biometric identification of users of a keyboard system, in which users are identified by characteristics of their input of keyboard data.

2. Background Information

People have long known about muscle-memory, and it is known that people have unique “typing” styles. In World War II, the recognized sending style of a telegrapher was called the “Fist of the Sender.” Experienced Morse code operators could recognize each other by their unique styles and this was exploited to ensure message authenticity. Muscle-memory and unique typing patterns are real.

For more than twenty years, various people have tried to develop a way to recognize these unique patterns in an effort to apply them to computer security.

Many verification technologies, indeed all prior art attempting to utilize keystroke information, make the assumption that people “have” patterns and that it is just a question of looking for them somehow. There have been numerous different methods of searching for these patterns proposed, from statistics to “neural networks.” Generally, a subject is asked to type, or key, a certain phrase or key sequences into a system some number of times. Then, using these samples, the prior art “looks for” or “learns” the pattern, based on whatever data was in the samples given. Nowhere is there an understanding of what constitutes a “good” sample. Moreover, users unaccustomed to learning how to type with a consistent keystroke pattern may have difficulty in logging into a verification system.

### SUMMARY

The embodiments of the present invention overcome problems found in the prior art and disclose a method for providing security to keyboard based systems. The method embodiment involves presenting a rhythm to teach a subject to type a recognizable rhythm, and then recognizing the patterns of typing by a subject using the system in which the subject's identity is confirmed.

Embodiments include an apparatus and method identifying a user of a keyboard input system. An enrollment engine defines a statistical relevance criterion that will qualify certain keystrokes in a group of keystrokes typed by a user as a mini-rhythm. An enrollment phase criterion indicates when text entered in an enrollment phase qualifies as meeting enrollment phase requirements. A password screener receives a proposed password from a user at a keyboard. Sensing the characteristics of password keystroke actions, the plurality of password keystroke characteristic data is stored in memory by the device. The password screener analyzes the password keystroke characteristic data against a banned rhythm dictionary. When password keystroke characteristic data matches a banned rhythm entry in the banned rhythm dictionary, it is rejected by the apparatus.

### BRIEF DESCRIPTION OF THE DRAWINGS

FIG. 1 is a diagram showing dwell and flight time calculation embodiment.

FIG. 2 is a row of a data array embodiment for one entry of sample text.

FIG. 3 is an embodiment of a table of data made of rows in which each row represents one entry of sample text.

FIG. 4 is an illustration of the distribution of data in accordance of an embodiment of the present invention.

FIG. 5 is a table that shows how information in columns is evaluated in accordance to an embodiment of the present invention.

FIG. 6 is a table showing how validation text is evaluated against sample text in accordance to an embodiment of the present invention.

FIG. 7 is a flowchart depicting a method embodiment of the present invention.

FIG. 8 is a flowchart of a password hardening method embodiment.

FIG. 9 flowcharts a trustable activation method embodiment.

FIG. 10 depicts a method embodiment showing rhythm guidance.

FIGS. 11a-c depict keyboard layouts in accordance with a password hardening embodiment.

FIG. 12 is a block diagram of a device embodiment of the present invention.

### DETAILED DESCRIPTION

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

Prior art keyboard recognition systems record and utilize the entire data string produced by typing a password, a selected target phase, or random text. By trapping a large volume of noise along with the small amount of real data that “might” or “might not” be present within a sample, the overall predictive value of any technique using the entire string of keystroke activity is weakened. One of the key insights of the technology of the present invention is that people only have reliable rhythms under certain circumstances. The technology of the invention defines these circumstances rigorously. Further, what constitutes “reliable” rhythms is defined rigorously and in advance. These small areas of reliable rhythms are termed “Mini-Rhythms.” The technology formalizes a technique for mini-rhythm development and recognition, and provides a mechanism to “quality assure” these mini-rhythms before they get into any “template” or “signature” created.

Further, and in stark contrast to all prior art, this technology works in high-security as well as the consumer “ATM” or “PIN” number situations. In high-security, the system looks at phrase lengths typically of fifteen or more characters. As phrase length increases, the sensitivity of mini-rhythm recognition can be increased to any level required. The claims specify keyboard based systems, and what is meant by that is, any character entry system, such as a computer keyboard, keypads, touch interfaces, telephone keypads, and all other character or touch entry systems.

The technology checks only a few (5-12 being typical) of the time variables and disregards the rest. This means that in a phrase of say twenty-five characters, where forty-eight measured variables (dwell and flight) are measured, only five to twelve of the forty-eight will typically be considered as “qualified” to be “mini-rhythms.” These are the only ones that are actually tested. The rest are not utilized in statistical evaluations and may even be discarded. Thus, 75-90% of the original “signal” is noise. As the phrase length is increased, the amount of noise as a percentage of the total increases, while the quality, or statistical reliability, of the mini-rhythms used increases. The mini-rhythms of the technology become better or more reliable as phrase length goes up. This is because there is more data to choose from and thus the mini-rhythms can be chosen from the most deeply learned passages, i.e. those with the tightest mini-rhythms.

The impact of these techniques on the high-security problem is huge. Mini-rhythms allow security systems to create very small “windows” to be tested. It is known that the real user can “hit” these small mini-rhythm windows because this is the definition of a mini-rhythm in the first place. The “real” user can have all kinds of variation in typing patterns because real users do have variations outside of the mini-rhythms. This kind of normal variation does not matter at all because the security technology of the invention only looks at certain, very small regions of known low variation in the typing patterns, which we call mini-rhythms. Our “real” user needs only be predictable regarding a few keystrokes of a selected phrase. An imposter, on the other hand, will need to hit every keystroke's flight and dwell time precisely. This is because he/she will have no idea where the mini-rhythms used in the security sequence are. In fact, even the “real” user has no idea which character groups form mini-rhythms for him/her. As we tighten the mini-rhythm windows, and lengthen the phrase, it quickly becomes impossible for an imposter to successfully mimic the real user. It is rather like a dance. The real user need only do a few “signature” moves precisely while the imposter needs to hit them all.

In measuring mini-rhythms, two events are typically evaluated, the key-down event and the key-up event. Their timing is noted. Other keystroke characteristics could also be sensed, recorded, and utilized, such as the physical key depressed, keystroke pressure, special key use, or other measurements. From this information, the variables are computed that will go into a mini-rhythm evaluation array.

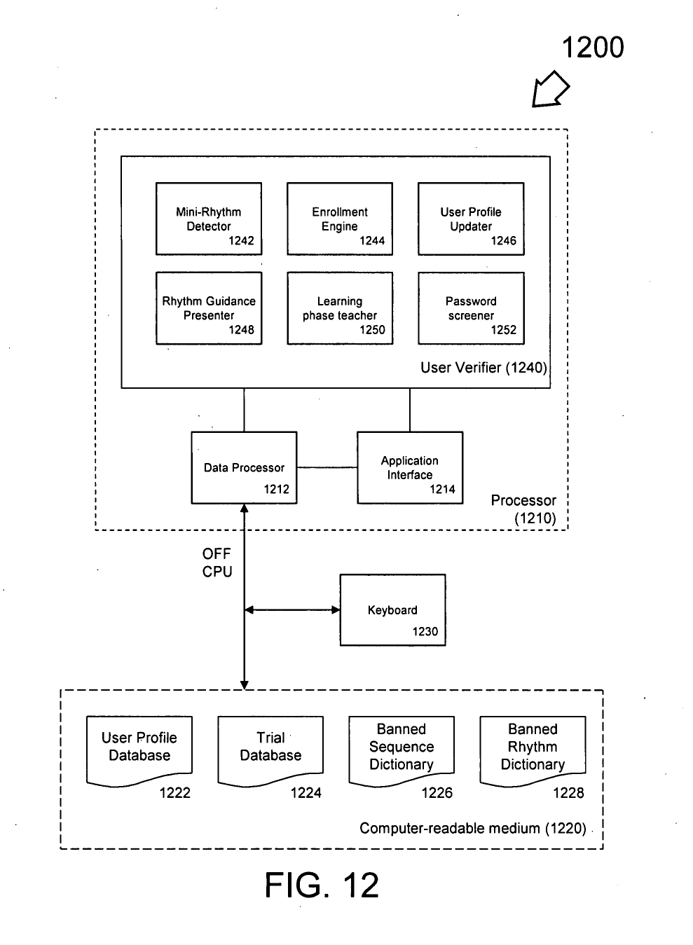

FIG. 12 is a block diagram of a biometric identification device 1200, constructed and operative in accordance with an embodiment of the present invention. Biometric identification device 1200 may run a real-time multi-tasking operating system (OS) and include at least one processor 1210. In some alternate embodiments, biometric identification device 1200 runs a standard non-real-time operating system. Processor 1210 may be any microprocessor or micro-controller as is known in the art.

The software for programming the processor 1210 may be found at a computer-readable storage medium 1220 or, alternatively, from another location across a communications network. Processor 1210 is connected to computer memory. Biometric identification device 1200 may be controlled by an operating system that is executed within computer memory.

Processor 1210 may communicates with a plurality of peripheral equipment, including keyboard 1230. In some embodiments, keyboard 1230 may be external to biometric identification device 1200. As shown in FIG. 12, Processor 1210 is functionally comprised of a user verifier 1240, data processor 1212, and an application interface 1214. User verifier 1240 may further comprise: mini-rhythm detector 1242, enrollment engine 1244, user profile updater 1246, rhythm guidance presenter 1248, learning phase teacher 1250, and password screener 1252. These structures may be implemented as hardware, firmware, or software encoded on a computer readable medium, such as computer-readable medium 1220.

Computer-readable storage medium 1220 may be a conventional read/write memory such as a magnetic disk drive, floppy disk drive, compact-disk read-only-memory (CD-ROM) drive, digital versatile disk (DVD) drive, flash memory, memory stick, transistor-based memory or other computer-readable memory device as is known in the art for storing and retrieving data. Significantly, computer-readable storage medium 1220 may be remotely located from processor 1210, and be connected to processor 1210 via a network such as a local area network (LAN), a wide area network (WAN), or the Internet. In addition, as shown in FIG. 12, computer-readable storage medium 1220 may also contain user profile database 1222, trial database 1224, banned sequence dictionary 1226, and a banned rhythm dictionary 1228. The function of these structures may best be understood with respect to the description below.

Data processor 1212 interfaces with displays, computer-readable medium 1220, keyboards 1230 and the like. The data processor 302 enables processor 1210 to locate data on, read data from, and write data to, these components.

Application interface 1214 enables processor 1210 to take some action with respect to a separate software application or entity. For example, application interface 1214 may take the form of a windowing graphical-user-interface, as is commonly known in the art.

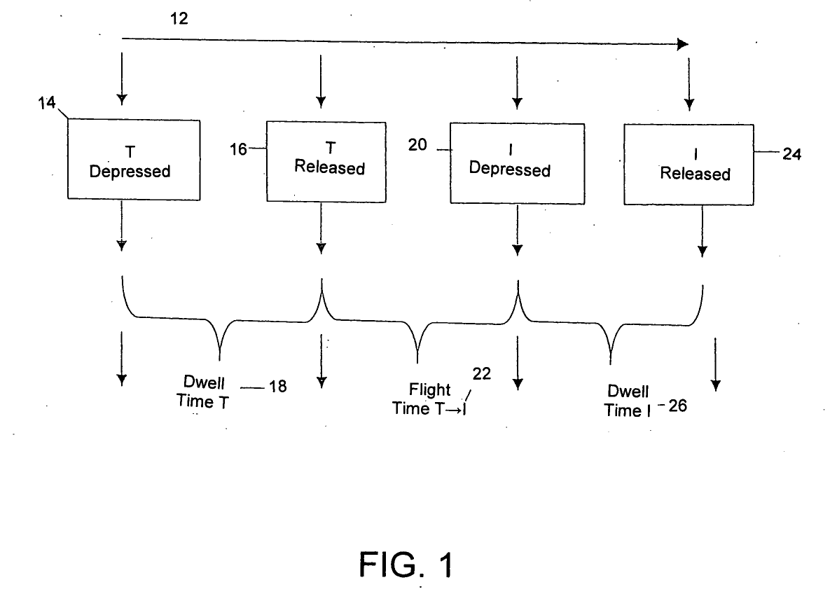

We turn now to FIG. 1, a diagram showing dwell and flight time calculation, constructed and operative in accordance with an embodiment of the present invention. Such calculations may be completed by mini-rhythm detector 1242. Each time the subject types in the sample text, one row of data is created that captures the keystroke characteristics across the entire phrase. FIG. 1 illustrates this action and shows the subject entering the characters “T” and “I.” The arrow 12 shows that time is passing beginning at block 14. When the “T” is depressed at block 14, Time Zero (T0) is noted. For simplicity, we show this as a value in milliseconds while in practice we can actually capture times with microsecond, or faster, resolution. When the “T” key is released at block 16, Time One (T1) is noted directly below. The difference between T0 and T1 is the Dwell Time 18 for this character of the sample text. When the “I” is depressed at block 20, Time Two (T2) is noted. The difference between T2 and T1 is the Flight time 22. When the “I” key is released at block 24, Time Three (T3) is noted directly below. The difference between T2 and T3 is the dwell time 26 for this character of the sample text. The Dwell and Flight times are stored as a record. This sequence of analysis continues for each character of the sample text.

Carrying this example further, we get a series of variables for the full phrase. For instance, the phrase “TIGERISAGOLFER”:

T → I → G → E → R → I → S → A → G → O → L → F → E → R
D F D F D F D F D F D F D F D F D F D F D F D F D F D

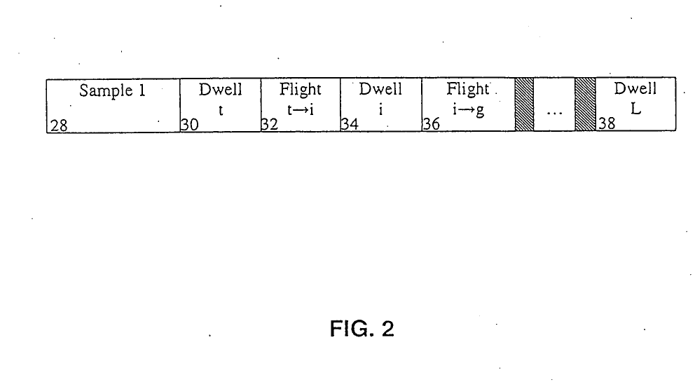

The Dwell and Flight times (D & F) for this phrase form the record shown in FIG. 2, in accordance with an embodiment of the present invention. Dwell and Flight times may be calculated by mini-rhythm detector 1242. In block 28, a particular sample number of an execution of the sample text is listed. Block 30 shows the first dwell time for the sample text. Block 32 shows the first flight time for the sample text, and blocks 34 and 36 continue this pattern for as many places as the sample text requires. Block 38 shows the last entry for the sample text, which is the dwell time on the last character of the sample text. Thus the dwell time at block 30 equals T1−T0, the flight time at block 32 equals T2−T1, the dwell time at block 34 equals T3−T2, and so on.

In order to be useful, the sample text must be completely “learned” by the subject. This means they must be able to type it without thinking. It must be a matter of “memory.” It is with memory that the unique mini-rhythms are developed. Indeed, they are the “way” a person remembers.

There is natural variability in everyone's rhythms. In the first part of the mini-rhythm detector 1242 embodiment (the Learning and Enrollment stages), mini-rhythms with low variability will be identified, or said more rigorously those with small σ (standard deviation) will be identified. The preferred sample text is one of sufficient length such that it will contain five, six, or more qualifying mini-rhythms. This translates into about nine to fifteen characters for most people. In a high security application, fifteen or more are used as the sample text length. This minimum length presents major challenges to an imposter. This is because the mini-rhythms could be anywhere. The imposter does not know where to look and therefore must try to emulate them all, each keystroke, dwell time, and flight time of each character. The longer the phrase, the harder this is. In addition, “phrase hardening” requirements are typically implemented. For instance, there should be few repeating letters/numbers/sequences that could simplify the required typing behavior we seek, and thus aid mimicry.

Ideally, it is desirable to use a phrase that is easy to remember, but one that would ordinarily not be typed as the sample text. Here are some examples of good sample texts:

tigerwoodsisagolfer

tigerwoodsisthebestgolfer

tigerwoodsisthebestgolferinthepga

nowisthetimeforall

All manner of flourishes can add complexity. For example, in “TigerWoodsIsTheBestGolfer,” the Shift key depression could be timed, and which (left or right) Shift key the subject picked could be sensed. Use of ALT, CTRL, and spacebar, or indeed any special keys work as well.

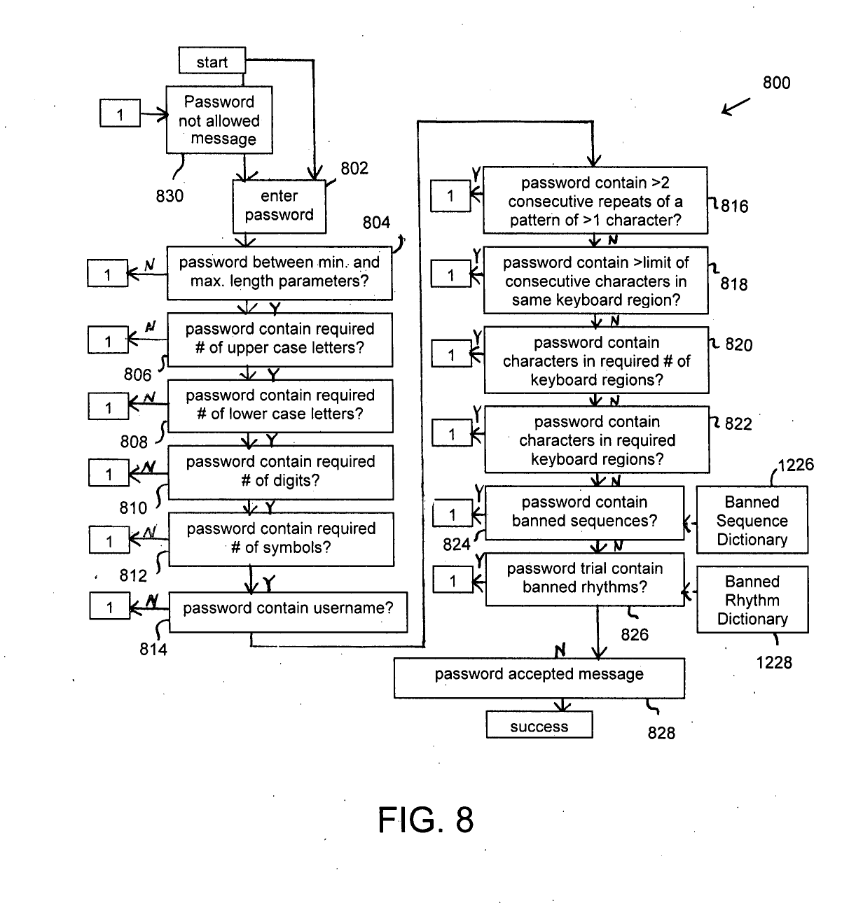

It should be noted that flourishes are mostly in the domain of “hardening” the password value of the phrase itself. The fundamental mini-rhythm layer is a separate function. It looks at the “Fist of the Sender” not the message per se. That said, the flourishes also have mini-rhythms. Password hardening will be discussed in greater detail below at FIG. 8.

The idea of mini-rhythm validation is to add a biometric check to the password layer. The mini-rhythm layer becomes a membrane residing behind the password. Moreover, it is an invisible membrane as well.

The Learning Phase

In order for mini-rhythms to function, the subject must have “learned” the sample text. Learning is defined as complete when the subject exhibits mini-rhythms equal to or exceeding specified minimum qualifiers when repeatedly typing the sample text in a structured environment. In other words, the subject must exhibit the development of mini-rhythms to exit the learning phase.

The subject enters the sample text and the dwell and flight times for each key are computed. This information makes one record in the mini-rhythm array, as shown in FIG. 2.

An example of a sample text could be “tigerwoodsisagolfer.” The timings for the keystroke characteristics are stored as a row, or record. In this case, there are thirty-seven variables (tigerwoodsisagolfer is nineteen characters long, and each character has dwell and flight except the first and last characters). The formula is Array=(N*2)−1, or (19*2)−1=37.

The “Enter” key terminates typing and indicates if the sample is valid. Note this can be any terminating key. If the subject hits a “correction” key, like the Backspace or Esc keys, the entire sample is rejected. Each sample process must run uninterrupted.

It is a requirement of the system that the subject give good samples. Subjects, under some circumstances, might try to defeat the system. One simple way to defeat the entire prior art of keystroke recognition is to simply give bad samples on purpose. By giving samples with high variability, a subject could cause prior art to create a bogus signature and one so weak that it would “recognize” virtually anyone typing anything even remotely close to the bogus signature samples. In the present system, if the subject does not provide good samples, the subject never exits the learning phase. The present system embodiment notes the presence of stable mini-rhythms across a significant sample base before any samples are accepted; ensuring the mini-rhythm signatures are tight, and guarding against the subject attempting to bias the mini-rhythms via phony variability It is presumed that during the learning phase, and the subsequent enrollment phase, the subject has been positively identified. Obviously, “imposters” cannot be allowed to enroll.

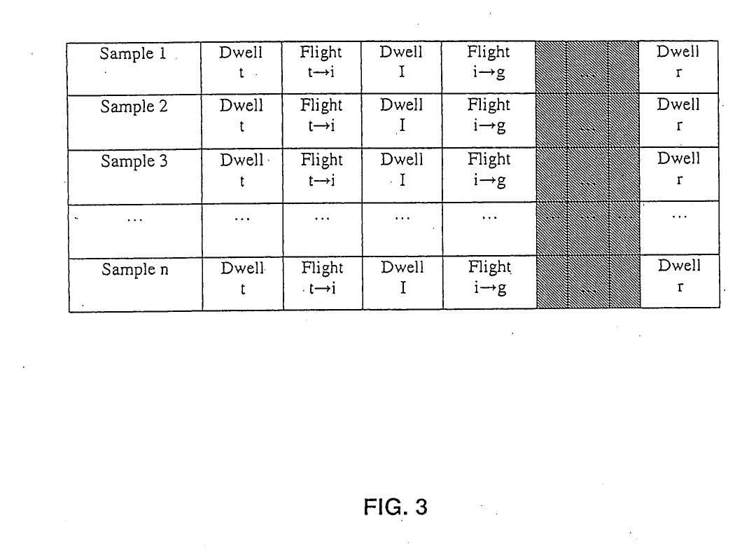

Next the method seeks mini-rhythms with high, predictive quality. This is accomplished by building the mini-rhythm array: The subject enters the sample text, hits the Enter key, then re-enters the sample text again, and hits the Enter key again. Each successive sample is a record, or row, in the mini-rhythm array. The mini-rhythm array is shown in FIG. 3, in accordance with an embodiment of the present invention.

After a few records, the system can begin to calculate the variables used by the mini-rhythm criteria and “seek” qualifying mini-rhythms. First, the mean (M) and standard deviation (σ) for each column are computed. Next, a in terms of M is calculated, which is a measure of variance. The timing array within each column conforms reasonably to a normal distribution. A good distribution will be a bell curve with very steep sides on the central peak.

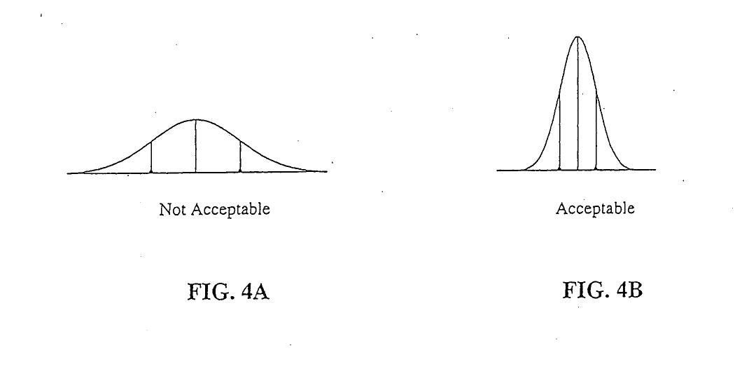

FIGS. 4A and 4B show graphical displays of possible data for a particular column in the array, representing data on the dwell or flight time of that column, constructed and operative in accordance with an embodiment of the present invention. The required statistical relevance of the data can be specified by the user, and one convenient way to do this is by looking at standard deviation in terms of the mean. If there is a large amount of variability in the samples recorded for any particular column, the data will appear more like the curve of FIG. 4A. When mini-rhythms are present, the times will be tightly grouped around the mean and the data will appear more like the curve of FIG. 4B. Data that appears more like FIG. 4B is more consistent in the enrollment phase, easier for the real user to repeat later, and will be harder for an imposter to duplicate in the verification phase. The mini-rhythm criteria essentially define how steep the curves in FIG. 4B must be to qualify variables, or variable groupings, as sufficiently learned and repeatable for use as a mini-rhythm.

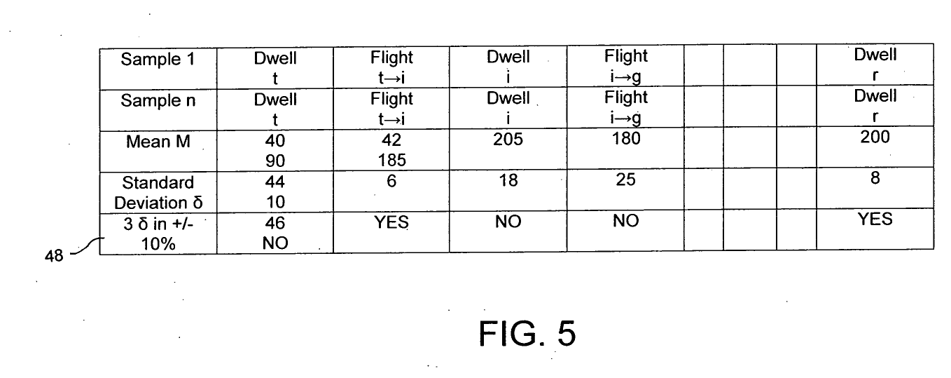

FIG. 5 is a table that shows how information in columns is evaluated in accordance with an embodiment of the present invention. FIG. 5 takes the array of FIG. 3 one step further. At block 40, the mean of 90 milliseconds is recorded as an example of the mean dwell time for the dwell times in that column (again and throughout, milliseconds are used for convenience and in practice, microsecond or faster timings are used). At block 42, the mean flight time for that column is shown. The means for the other columns are similarly calculated. At block 44, the standard deviation of the data in the column is shown. In block 46, an evaluation of whether the figure in block 44 meets example acceptance criteria is presented. By reading the results shown in row 48, it can be seen how many mini-rhythms were satisfactory entered. The number of mini-rhythms identified in the sample set is compared to the minimum number of mini-rhythms required for enrollment acceptance. If sufficient mini-rhythms exist in the array, the user may exit enrollment successfully.

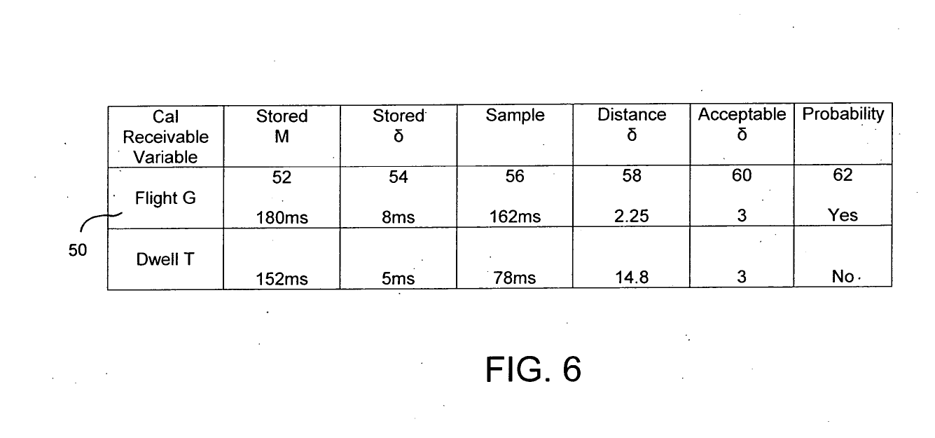

FIG. 6 is a table that shows example criterion for verifying a user in the verification phase, as used by the user verifier 1240, in accordance with an embodiment of the present invention. Each row has information about a particular entry of the sample text. For instance, row 50 shows data for the flight time of a “G” character entered with the sample text. Block 52 shows the mean of the entries of this character from the previous enrollment phase entries. In this case, the mean flight time for “G” is 180 milliseconds. Block 54 shows the standard deviation of the enrollment phase entries. In this example, the standard deviation is shown as 8 ms. In block 56, the flight time of the example actual verification entry is 162 ms. In block 58, the number of standard deviations for this verification entry is calculated as 2.25 standard deviations. The criterion for acceptance of the verification entry is listed in block 60. The criterion for acceptance in this example is 3 standard deviations, so the verification sample meets that requirement. The result of the comparison is shown in block 62, as a yes. For any particular verification text, there will be a number of mini-rhythms present. For instance, a twenty character phrase might yield twelve mini-rhythms (out of the thirty-nine possible Dwell/Flight variables), which would correspond with 12 rows in a table such as that in FIG. 6. Depending on other statistical qualifiers, the subject would normally have a certain number of acceptable mini-rhythms present, such as ten to twelve. Other ranges of acceptable mini-rhythms, such as six to nine or zero to five, might be used to trigger certain actions such as to reenter the verification text, or to signal a monitor to observe the subject.

During enrollment, the subject can typically achieve a very narrow grouping of times for each mini-rhythm, with small absolute time windows. Both are important qualifiers. One way mini-rhythms are qualified is by looking at how many times σ can fit within ±QM % of M (QM=qualifying margin). For instance, if a subject had submitted enrollment sample values that calculated to M=150 ms and σ=5 ms, and if ±10% was chosen as the QM goal, 3σ fits into our 10% margin (150*0.10=15, 15/5=3). Said another way, our subject will normally be within 10% of M in about 99 out of 100 attempts. Thus, a mini-rhythm defined. A typical user typing naturally will be within the mini-rhythm defined range of acceptable results without effort. Mini-rhythms are highly tunable.

Mini-rhythm qualification has three main “tunable” parameters. These are discussed below. Note: Timings are shown in milliseconds for ease of reading and clarity. In practice, timing resolutions of a microsecond, or finer, are used.

The plus/minus (±) distance from M within which σ fits are counted and referred to here as the Qualifying Margin (QM), which is a percentage. In the above example, 10% was used on either side of M, equating to QM=5 ms for our example of M=150 ms. Raising this number makes it easier for the subject to qualify a mini-rhythm because it allows for more variability. Raising this number also shortens the learning process. Tightening this number has the reverse effect. It requires deeper learning from the subject, meaning more repetitions. However, it also “tightens” the mini-rhythm as an intruder-detection metric.

The number of fits is the number of times σ in milliseconds goes into the QM in milliseconds. Therefore, if the QM=50 ms±for a given variable, and σ=10 ms, then NF=5. Said another way, 5σ or 99.9999% of the time, a subject qualifying at NF=5 will repeat the mini-rhythm behavior with a time that conforms to within ±50 ms (5σ) or a total variance of 100 ms.

Raising the NF required for qualification has some interesting, and subtle, effects. First, raising the NF will increase the required learning effort for the subject. However, raising the NF actually makes it easier for the subject on subsequent verifications. The reason is, by definition, the higher the NF required, the more often the subject will actually be able to “do” the behavior. In other words, a mini-rhythm that is present to 5σ is something deeply ingrained in the subject. This is a very highly learned behavior and highly trustable. The subject “does” this. The higher the NF within a given QM, the more useful mini-rhythms are as biometric indicators. Therefore, the higher the security desired, the higher the NF should be. One a accounts for 68% of the subject's mini-rhythm variability. Two σ accounts for 95% and 3σ for 99%. Four σ and five σ take it to about 99.99% and 99.9999%, respectively. At NF=6, our subject will hit within the QM 999,997 out of 1,000,000 times and has “Six Sigma” mini-rhythms. In most cases, a NF of two or three will suffice.

Qualifying variables (QV) (dwell and flight) is the number of mini-rhythms that must be present to generate a valid signature, thus they must equal (or exceed) the selected values of QM and NF. To be useful, QV should be set to at least three, with five or more preferable. In a high security environment where QM and NF are set and require deep learning, and phrase length is set to fifteen to twenty characters or more, it is not uncommon to see twelve or more variables that meet the QM/NF criteria. QV is the minimum that must be met. During the enrollment phase, the subject must continue to enter samples (type the sample text) until at least the QV has mini-rhythms that meet the qualification criteria. Earlier the phrase “tigerwoodsisthebestgolfer” was used. In that example, setting QV=6 means that 6 out of the 49 possible variables must pass the QM/NF test. Note: it can be any six. This is interesting because even the subject will not be aware of “which” six mini-rhythms our algorithm is using. There is nothing for them to “try” to do. They just type. Therefore, the imposter must attempt to hit all forty-nine variables to within QM/NF tolerance. Another complication for the prospective imposter is the fact that the real subjects themselves do not hit all forty-nine mini-rhythms on the nose. They only hit some of them, and the tolerances are tight. Casual eavesdropping is likely misleading.

As mentioned earlier, mini-rhythms are useful as “warning bells.” If the real subject misses one or two mini-rhythms in a subsequent verify process, which may be okay. If the real user misses three, that is very unusual. If the user misses four or five or more, something is definitely wrong. Either the subject is an imposter and an intrusion-attempt in-progress, or something is wrong (as in psychologically or physically) with the user. As a performance measure, mini-rhythms are capable of remotely detecting mind-altering substance use or potentially stress and mood changes. With respect to intrusion, they offer the prospect of real-time and covert alerts.

The Optional Learning Phase

For most people, it will take ten to twenty “practice” attempts before their mini-rhythms form and settle. Some people may need more practice efforts. It depends on the subject, the degree of learning required, and if the invested time is contiguous. The subject can rest during this process, stop, and later resume. Indeed this is desirable to combat fatigue.

A “Learning” mode, as administered by the learning phase teacher 1250, may be used to monitor the practice typing for the emergence of mini-rhythms. It is useful to give the user feedback on learning progress and to alert them when learning has succeeded.

Learning is successful when at least QV variables are found that equal or exceed the QM and NF parameters across a small number of the most recent samples, where the last five samples given are as an example. Five samples is not a statistically valid sample size, but seeing QV across five samples in a row is enough to indicate learning.

The process can be given another measurable attribute by looking at learning curves as well. As long as the subject is improving a on some variables, it is reasonable to allow the “learning” phase to continue past QV variables, and/or the QM and NF goals within QV. In other words, it is desirable for the a to settle to as low a number as possible, on as many variables as possible.

An option is to give the subject running feedback during the learning process to let them know how they are doing, and perhaps estimate how much more time, or how many more samples, will be required for success.

Once learning successfully concludes, the subject can go on into the mini-rhythm enrollment phase, as administered by enrollment engine 1244.

The Enrollment Phase

Although the number can be smaller, in order to be statistically rigorous, a minimum number of samples are included in the mini-rhythm array. Usually, the minimum is set to thirty, although it could be as few as ten and as many as 100 or more. The sample pool must yield at least QV variables that equal or exceed the QM and NF parameters selected. When these are present, the mini-rhythm enrollment phase is complete.

Like the Learning Phase, the subject is asked to type the chosen sample text repeatedly. The subject is advised of exactly what he is doing, and what he needs to do to succeed in generating a valid mini-rhythm signature. Again, the patterns must be stable across the full minimum sample pool. Since the subject has succeeded in learning, it is known that the subject “can” do the behaviors. Therefore, while the subject is making samples for mini-rhythm signatures, the system needs to be sensitive to any outliers the subject presents. Some subjects will get tired. Some will “try” too hard. Some will get cute. Some will try to defraud the system.

One way that a subject may try to defeat the system is to vary their keystroke rhythms during the enrollment phase. The thinking is that the greater the variability in the profile, the easier it will be to “break” it later. This is exactly why this is not allowed. The subject has to hit the mini-rhythm targets or they never successfully create a signature and never exit the mini-rhythm Enrollment Phase. In this respect, the Enrollment Phase is like the Learning Phase—the only exit is success, defined as mini-rhythms that meet or exceed the system's criteria. False signatures are never allowed.

To deal with the cases of bad samples mid-process (honest subjects), and fully false data (dishonest subjects), an array of computed M and a historical values, in addition to the timings, is kept. From this array we compute learning curves. A normal person doing an honest sample set will experience a learning curve. The values for a will fall. If this does not happen, or if it was happening and is now not, there is some problem. In the first case, it is probable that the subject is not responding honestly. In the second case, it is likely that the subject was distracted in some way, particularly if it is a one-sample blip.

If an outlier is observed, it can be eliminated from the calculations. This can be caused by the occasional interruption or distraction. The subject can also be advised of the problem and a brief rest taken. With large-scale testing, optimal rest intervals and the most effective subject feedback can be determined. If an unstable pattern or an intermittent. problem is observed, the subject may be impaired or being less than forthright. The subject can also be advised of this.

Generally speaking, the subjects correct their own outliers. This is because they have a “correction” key or keys such as, the Backspace or Esc keys. If they make mistakes in a rhythm because of fatigue or distraction, or any reason, they can hit the correction key to discard the entire sample and start over again. In this way, hitting the “Enter” key is a proactive statement on the subject's part that the sample just keyed is “good”.

In any event, the mini-rhythm Enrollment Phase lasts until the subject successfully provides samples demonstrating reliable mini-rhythms to within the established tolerances across a number of samples equal to the minimum sample pool size chosen.

Once the Enrollment Phase has concluded, the mini-rhythms should be well established for a considerable period of time, particularly if the subject has some opportunity to re-exhibit their learned mini-rhythms. If extended time passes, or if the subject has some major physical change, they may need to perform the Learning and/or Enrollment Phase(s) again. In the worst case, the subject can re-learn and re-enroll from scratch, which is not difficult to do.

Recognizing People via Mini-rhythms: Verification

After the Enrollment Phase, a subject's identity may be confirmed using a Verification Phase by the user verifier 1240. For verification, the subject types in the enrollment text. The keystroke event times are compared to the mini-rhythms in the stored signature data.

For each mini-rhythm in the enrolled signature, the stored M and σ values are compared to the time measured in the current sample. An example of this comparison is shown in FIG. 6.

A subject can normally and easily type in his/her sample text and get all “greens.” However, sometimes he/she will make a mistake and it is also possible that he/she will miss them all if they are not “normal.” A subject could be under heavy stress, physically ill, or intoxicated, wherein he/she will not give a “normal” performance.

However, the statistics are extremely reliable for an authentic subject. If, for example, the subject exhibits five mini-rhythms with QM=20 and NF=2, this means, for each mini-rhythm, the subject is within 20% of the Mean 95% of the time. Said another way, the subject misses 5% of the time when in a normal mental and physical state. Since a “normal” miss on one mini-rhythm can be considered to be unrelated to a miss on any other mini-rhythm, we can use the multiplicative rule. This yields 5% times 5% or 0.25% chance of missing two. The probability of missing three, four, or five mini-rhythms are similarly calculated, and result in extremely low probabilities. However, if a user is affected by drugs, the condition precedent affects these keystrokes and different statistics apply. As noted, physical illness and even stress can affect timings.

If the system senses a number of “red” lights, the user is likely to be an intruder. Said differently, each missed mini-rhythm increases the real-time risk of an intrusion in-progress. The system can then take the appropriate steps with actions depending of the “degree of risk” measured by the number of missed mini-rhythms.

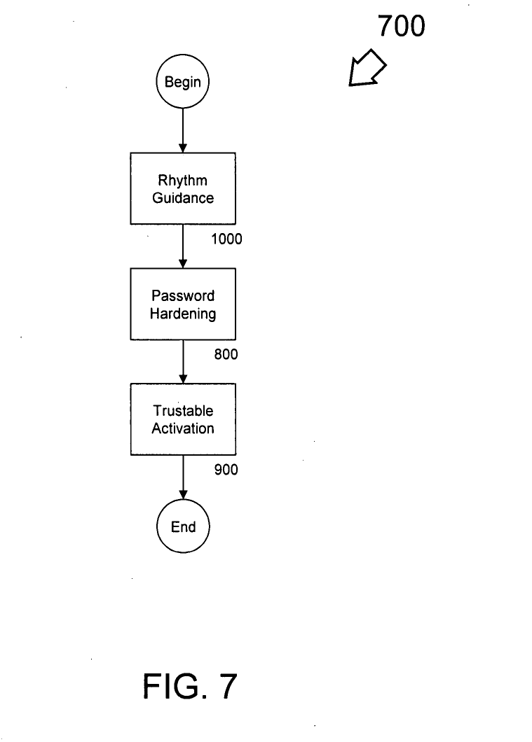

Turn now to FIG. 7, which depicts a biometric identification method 700 embodiment, in accordance with an embodiment of the present invention. Biometric identification method 700 may comprise blocks for rhythm guidance 1000, password hardening 800, and trustable activation 900. After reading the descriptions of blocks 700-1000 below, it will be readily understood by those familiar with the art that blocks 700-1000 may be combined in any combination to form biometric identification method 700.

FIG. 8 is a flowchart of a password hardening method 800 in accordance with an embodiment of the present invention. In some embodiments of the present invention, password hardening method 800 may be performed by password screener 1252. Initially, a password is received at block 802. Password hardening 800 may be thought of as the process of making a password more secure by placing restrictions on an allowed password.

Blocks 804-828 may be used in any combination, and may make passwords hard to guess. For example, some embodiments may only use the restrictions of blocks 804, 808, 824, and 826. Another embodiment may use restrictions from 814-822. It is understood by those known in the art that embodiments may be designed to use any variation thereof.

In concept, blocks 804-828 are commonly referred to as password “hardening” and are particularly an issue when users are allowed to choose their own passwords.

It is understood by those familiar with the art that a number of best practice guidelines have been developed and generally accepted for use with normal password-only systems. These include blocks that limit the minimum and maximum length of password parameters 804, requiring a minimum number of upper case letters 806, requiring a minimum number of lower case letters 808, requiring a minimum number of numerical digits 810, must contain a number/symbol 812, or restricting the use of dictionary words or user names 814. If the any of the requirements of blocks 804-814 are not found, flow continues to block 830 and the password is not allowed. Otherwise, flow continues to block 816.

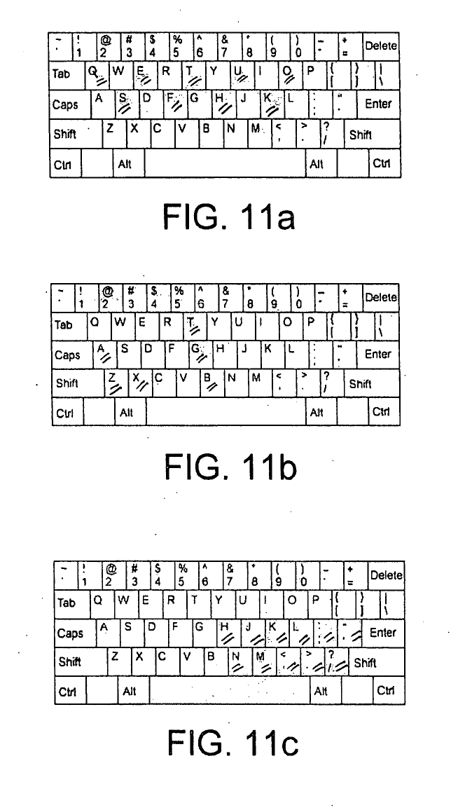

For passwords used as a part of a keystroke-rhythm biometric system 1200, conventional hardening policies may be supplemented with additional rhythm restrictions, as described below in blocks 816-826. Block 816 restricts passwords that contain more than two consecutive repeats of a pattern of one or more characters. An example of a pattern of characters is shown in FIGS. 11a and 11b. Additional restrictions, such as repeating characters (11112222) and keyboard strings (examples below) may also be restricted at block 816.

Block 818 restricts passwords that contain more than the limit of consecutive characters in the same keyboard region. In concept, the keyboard may be broken into any number of regions as shown by the four regions depicted in FIG. 11c. Through restricting consecutive characters in the same keyboard region prevents easily hackable passwords from being used. Similarly, block 820 requires passwords contain characters in a minimal number of keyboard regions. This restriction may prevent passwords from being typed in a single hand or keyboard region. Block 822 may require passwords contain characters in a required keyboard region.

At block 824, password screener 1252 compares passwords with a banned sequence dictionary 1226. A banned sequence dictionary 1226 may be any file, data structure, database, or dictionary known in the art that contains a banned sequence of characters from being used as a password. For example, banned sequence dictionary 1226 may include banned character sequences that form offensive words, terms or phrases. Profanity or proper names may be excluded by use as passwords through the use of such a banned sequence dictionary 1226.

Moving to block 826, rhythms are checked against a banned rhythm dictionary 1228. Banned rhythm dictionary 1228 may be any file, data structure, database, or dictionary known in the art that contains a banned sequence of mini-rhythms from being used in a password. For example, banned rhythm dictionary 1228 may include banned mini-rhythm sequences that are too regular, and obviously machine-simulated.

If the any of the requirements of blocks 816-826 are not satisfied, flow continues to block 830 and the password is not allowed. Otherwise, flow continues to block 828, and the password is accepted.

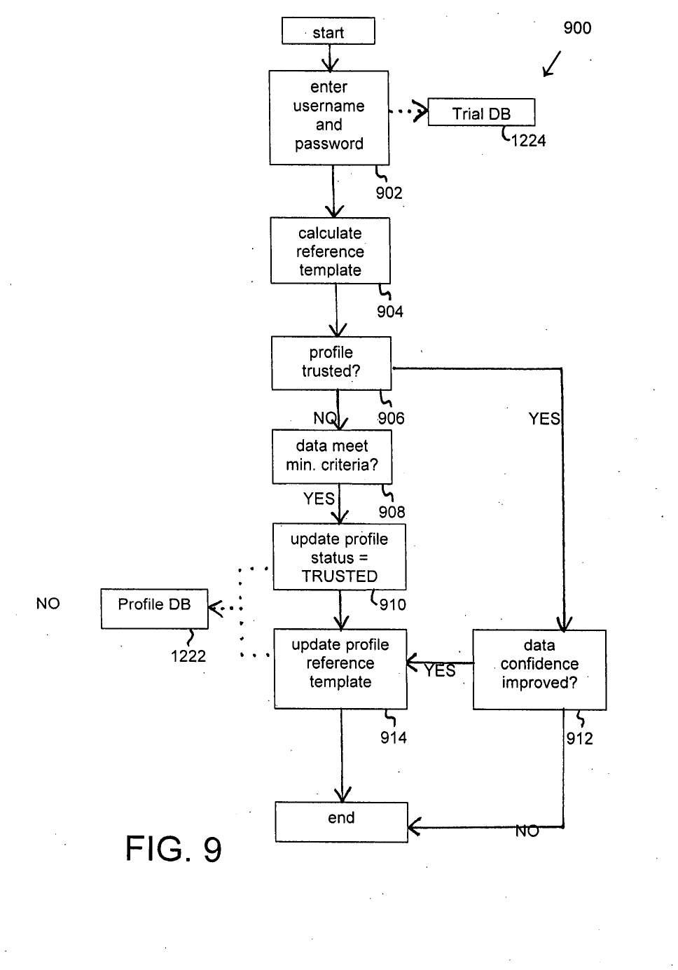

FIG. 9 flowcharts a trustable activation method 900 in accordance with an embodiment of the present invention. Unlike traditional password systems, biometric identification methods may continuously update the mini-rhythms used to identify users. As will be readily understood by those familiar with the art, trustable activation method 900 may be combined with any of the embodiments described herein. In some embodiments, trustable activation 900 is implemented through use of the enrollment engine 1244 and user profile updater 1246.

Trustable Activation 900 may be thought of as enrollment phase logons embedded transparently into normal logon workflows. Trustable activation 900 may gather the totality of each user's real logon behavior—first logon in the morning, before coffee, after, when tired, when stressed, etc—rather than some artificial (type this N times) process. Once the user meets the enrollment criteria in this manner the system can “trustably” activate with excellent recognition rates under real-world circumstances.

Initially the user is queried for their username and password, block 902. The login attempt is recorded at the trial database 1224.

The login attempt is compared to a calculated reference template, block 904.

If the profile is trusted, as determined by decision block 906, flow continues at decision block 912. At decision block 912, if the login data is of high confidence, and the process flow continues at block 914.

If the profile is not trusted, a comparison is made to determine whether the login information meets minimum criteria at block 908. If allowed, the user profile is changed to trusted status, block 910, and the process flows to block 914.

At block 914, the user's profile in the profile database 1222 is updated with the login information, block 914, and process 900 ends.

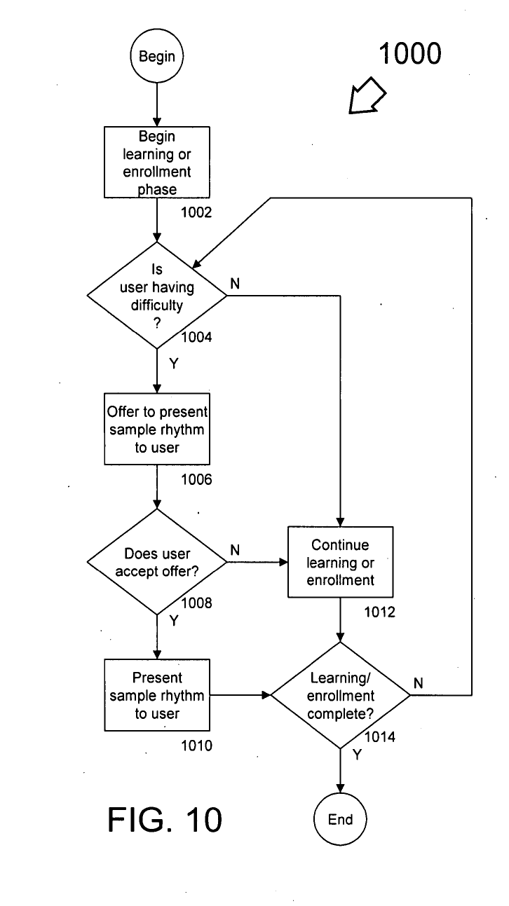

FIG. 10 depicts a rhythm guidance method 1000, constructed and operated in accordance with an embodiment of the present invention. In methods discussed above, each user was allowed to type their password or phrase during learning mode and enrollment without any coaching—that is they develop whatever typing rhythm they like in a natural manner, or at least in their chosen manner. However it is possible to provide rhythm guidance 1000 during both learning and enrollment, block 1002.

Rhythm guidance method 1000 speeds enrollment. For some applications, like consumer internet logons, it is desirable to generate a signature quickly in one session, as opposed to inducting in naturally over multiple real logons over multiple sessions. Just having the user type their word N times has problems—users get on “rolls” and develop patterns that are artificial and which they have trouble doing again later on in a normal logon, block 1004. The user is offered a sample rhythm to master, block 1006. If the user accepts the offer at decision block 1008, a sample rhythm is presented to the user, block 1010. In such cases, feedback in terms of rhythm guidance aids in the process. This can take several forms but all essentially involve feedback during the learning process. The user may be supplied with a “target” rhythm—Dum da da . . . dum dum . . . da . . . dum—that they try to emulate for the entire phrase, or they can be “led” a couple characters at a time—Dum da da—until they learn that, then—Dum da da . . . dum dum—and so on in “Simon Says” fashion, block 1010.

It is understood that such rhythms may be generated by the rhythm guidance presenter 1248, or retrieved from a pre-stored database of pre-generated rhythms. In some embodiments, the rhythms may be associated with sample text presented to a user. In other embodiments, the rhythms selected by the rhythm guidance presenter 1248 may be chosen because they contain a selected number of mini-rhythms which form the basis of a statistical relevance criterion, defining the number of qualified mini-rhythms required to constitute a valid enrollment.

By combining feedback (audio and/or visual) the user can be led to a stable rhythm in a quicker fashion. These additional cues will also help them recall their pattern later—whether they are only “heard” in the user's head or explicitly given as a prompt. Learning or enrollment continues at block 1012 until the enrollment or learning is completed at block 1014. Interestingly, this type of prompting does not significantly weaken the acuity of our recognition because the user still develops their own unique way of doing the rhythm—we all have a different drummer.

Rhythm guidance and feedback can make the enrollment process significantly more enjoyable. This is particularly important in consumer applications. No matter how you slice it, entering your username/password/etc over and over is not all that fun. Feedback really helps and makes it possible to incorporate effective learning into a game format.

Rhythm guidance 1000 may be used in conjunction with a password hardening embodiment 800. Look at the phrase “marthastewart”. Such a phrase may be parsed as “martha-stewart”, inserting breaks where the word breaks naturally go. If this phrase were used as a password it is very likely these breaks would be assumed by an imposter too—it is hard to stop yourself from seeing it that way. Hence, if we were to break up the phrase differently—e.g.—mart-haste-wart—and then “teach” that via rhythm guidance—we get a much more difficult pattern for any imposter to emulate given only knowledge of the “marthastewart” phrase. As already stated, even if someone were given the “secret knowledge” of the breaks—mart-haste-wart—they would still have to match the unique pattern. The bottom line is rhythm guidance 1000 can make mini-rhythm (biometric) passwords much harder to emulate. This concept may be extended to high-security environments (where security is the most important issue) by breaking down longer phrases—nowisthetimeforallgoodmentocometotheaidoftheircountry—into nonsense chunks taught with feedback and Simple Simon to ingrain the pattern.

During a subsequent logon (verify), a user having trouble producing their pattern they could be provided their rhythm “cue” as help. This would have the effect of reducing frustration/increasing user satisfaction, while not significantly helping an imposter. Security is only one issue—user satisfaction is equally (or more) important in many applications.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

We claim:

1. A password hardening method in a keyboard input system, comprising:
defining a statistical relevance criterion that will qualify certain keystrokes in a group of keystrokes typed by a user as a mini-rhythm;
defining an enrollment phase criterion to indicate when text entered in an enrollment phase qualifies as meeting enrollment phase requirements;
receiving a proposed password from a user at a keyboard;
sensing characteristics of password keystroke actions made when the user enters the proposed password;
storing a plurality of password keystroke characteristic data in memory;
analyzing the plurality of password keystroke characteristic data against a banned rhythm dictionary, the banned rhythm dictionary comprising at least one banned rhythm entry;
rejecting the proposed password when the plurality of password keystroke characteristic data matches a banned rhythm entry in the banned rhythm dictionary.

2. The method of claim 1, further comprising:
analyzing the plurality of password keystroke characteristic data against the statistical relevance criteria to identify if one or more groupings of password keystroke actions qualify as a mini-rhythm and selectively using only mini-rhythm data from the password;
analyzing the mini-rhythm data to verify that the enrollment phase criteria have been met;
storing the mini-rhythms in memory as identified mini-rhythms unique to the user.

3. The method of claim 2, further comprising:
storing the proposed password in a user profile database when the plurality of password keystroke characteristic data does not match any banned rhythm entry in the banned rhythm dictionary.

4. The method of claim 3, in which the statistical relevance criterion is defining the number of samples across which the mini-rhythms must be present.

5. The method of claim 4, which further includes:
building a mini-rhythm array comprised of a plurality of records, in which each record in the array is comprised of dwell and flight times of the characters in the password, and the records form columns, with each column being flight or dwell times for the same character in the password, from different entries of the password.

6. The method of claim 5, further comprising:
analyzing data in each column of the mini-rhythm array for mean and standard deviation.

7. The method of claim 6, further comprising:
dividing the keyboard into more than one region and requiring the proposed password to contain characters from at least a required number of keyboard regions.

8. The method of claim 6, further comprising:
rejecting the proposed password when the proposed password contains more than two consecutive repeats of a rhythm pattern.

9. The method of claim 6, further comprising:
dividing the keyboard into more than one region, and rejecting the proposed password when the proposed password contains more than four consecutive characters from the same keyboard region.

10. An apparatus to screen a password entered by a user of a keyboard input system, comprising:
an enrollment engine configured to define a statistical relevance criterion that will qualify certain keystrokes in a group of keystrokes typed by a user as a mini-rhythm, to define a enrollment phase criterion to indicate when text entered in an enrollment phase qualifies as meeting enrollment phase requirements;
a password screener configured to receive a proposed password from the user at a keyboard;
a data processor configured to sense characteristics of password keystroke actions made when the user enters the proposed password, configured to store a plurality of password keystroke characteristic data in memory;
the password screener being further configured to analyze the plurality of password keystroke characteristic data against a banned rhythm dictionary, the banned rhythm dictionary comprising at least one banned rhythm entry, and configured to reject the proposed password when the plurality of password keystroke characteristic data matches a banned rhythm entry in the banned rhythm dictionary.

11. The apparatus of claim 10, further comprising:
a user profile database configured to store the mini-rhythms identified as unique to the user; and
wherein the enrollment engine is further configured to analyze the plurality of password keystroke characteristic data against the statistical relevance criteria to identify if one or more groupings of password keystroke actions qualifies as a mini-rhythm and selectively using only mini-rhythm data from the password, configured to analyze the mini-rhythm data to verify that the enrollment phase criteria have been met.

12. The apparatus of claim 11, wherein the password screener is further configured to store the proposed password in a user profile database when the plurality of password keystroke characteristic data does not match any banned rhythm entry in the banned rhythm dictionary.

13. The apparatus of claim 12, in which the statistical relevance criterion is defining the number of samples across which the mini-rhythms must be present.

14. The apparatus of claim 13, in which the enrollment engine is further configured to build\ a mini-rhythm array comprised of a plurality of records, in which each record in the array is comprised of dwell and flight times of the characters in the password, and the records form columns, with each column being flight or dwell times for the same character in the password, from different entries of the password.

15. The apparatus of claim 14, which the enrollment engine is further configured to analyze data in each column of the mini-rhythm array for mean and standard deviation.

16. The apparatus of claim 15, in which the password screener is further configured to divide the keyboard into more than one region and requiring the password to contain characters from at least a required number of keyboard regions.

17. The apparatus of claim 15, in which the password screener is further configured to reject the password when the password contains more than two consecutive repeats of a rhythm pattern.

18. The apparatus of claim 15, in which the password screener is further configured to divide the keyboard into more than one region, and rejecting the proposed password when the proposed password contains more than four consecutive characters from the same keyboard region.

19. A computer-readable medium, encoded with data and instructions to identify a user of a keyboard input system, that when executed by a computing device, causes the computing device to:
define a statistical relevance criterion that will qualify certain keystrokes in a group of keystrokes typed by a user as a mini-rhythm;
define an enrollment phase criterion to indicate when text entered in an enrollment phase qualifies as meeting enrollment phase requirements;
receive a proposed password from a user at a keyboard;
sense characteristics of password keystroke actions made when the user enters the proposed password;
store a plurality of password keystroke characteristic data in memory;
analyze the plurality of password keystroke characteristic data against a banned rhythm dictionary, the banned rhythm dictionary comprising at least one banned rhythm entry;
reject the proposed password when the plurality of password keystroke characteristic data matches a banned rhythm entry in the banned rhythm dictionary.

20. The computer-readable medium of claim 19, which further includes instructions to:
analyze the plurality of password keystroke characteristic data against the statistical relevance criteria to identify if one or more groupings of password keystroke actions qualify as a mini-rhythm and selectively using only mini-rhythm data from the password;
analyze the mini-rhythm data to verify that the enrollment phase criteria have been met;
store the mini-rhythms in memory as identified mini-rhythms unique to the user.
